(19) United States
(12) Patent Application Publication
(10) Pub. No.: US 2026/0011944 A1
(43) Pub. Date: Jan. 8, 2026

(54) Signal Transmission Component Assembly and Electrical Connector and Connector Assembly Thereof

(71) Applicants: Tarng Yu Enterprise co., ltd., New Taipei City (TW); Dongguan Tarng Yu Electronics Co., Ltd., Dongguan City (CN)

(72) Inventors: YING-CHUNG CHEN, New Taipei City (TW); MU-JUNG HUANG, New Taipei City (TW)

(21) Appl. No.: 19/257,384

(22) Filed: Jul. 1, 2025

(30) Foreign Application Priority Data
Jul. 5, 2024 (TW) 113207303

(51) Int. Cl. H01R 12/75; H01R 4/2406; H01R 4/2429; H01R 9/24; H01R 12/70; H01R 13/502; H01R 107/00

(52) U.S. Cl. CPC H01R 12/75; H01R 4/2406; H01R 4/2429; H01R 9/2416; H01R 12/7082; H01R 13/502; H01R 2107/00

(57) ABSTRACT

A signal transmission component assembly and an electrical connector and a connector assembly thereof, wherein the electrical connection with a conductive cable can be achieved without the need for a cable-end connector, thereby saving internal space within the electronic device and enabling continued development of electronic devices toward a thinner, lighter, and more compact form.

### CROSS-REFERENCE TO RELATED APPLICATIONS

This application claims the priority of Republic of China Patent Application No. 113207303 filed on Jul. 5, 2024, in the State Intellectual Property Office of the R.O.C., the disclosure of which is incorporated herein by reference.

### BACKGROUND OF THE INVENTION

### Field of the Invention

The present application relates to the technical field of electronic devices, and more particularly, to a signal transmission component assembly and an electrical connector and a connector assembly thereof, which are capable of achieving electrical connection with a conductive cable without the need for a cable-end connector.

### Descriptions of the Related Art

In modern electronic devices, it is common to provide cable-end connectors and electrical connectors. Generally, the cable-end connector is electrically connected to the conductive cable, while the electrical connector is electrically connected to the cable-end connector. Accordingly, the electrical connector can achieve electrical connection with the conductive cable via the cable-end connector to transmit electrical signals.

However, with the rapid advancement of technology, electronic devices have become increasingly thinner, lighter, and smaller, resulting in more limited internal space. Since the cable-end connector occupies valuable internal space in the electronic device and increases the complexity and cost of assembly, how to enable the electrical connector to achieve electrical connection with the conductive cable without the use of a cable-end connector has become a problem urgently to be solved by those skilled in the art.

### SUMMARY OF THE INVENTION

In view of the drawbacks of the prior art mentioned above, the present application provides an electrical connector, comprising: configured to be used with a conductive cable, the electrical connector comprising: an electrical connector body comprising an electrical connector body threading passage and an electrical connector body inserting hole, wherein the electrical connector body threading passage is configured for threading the conductive cable, and the electrical connector body inserting hole is in continuity with the electrical connector body threading passage; an electrical connector conductive terminal comprising an electrical connector terminal inserting structure; and an electrical connector terminal core configured to mate with the electrical connector conductive terminal and to be assembled with the electrical connector body, such that the electrical connector terminal inserting structure is capable of being inserted into the electrical connector body threading passage through the electrical connector body inserting hole to be inserted into the conductive cable to electrically connect the electrical connector terminal inserting structure to the conductive cable.

Preferably, the electrical connector said above, wherein the electrical connector body inserting hole and the electrical connector body threading passage intersect substantially perpendicularly.

Preferably, the electrical connector said above, wherein the electrical connector terminal core comprises a first electrical connector terminal core locking structure, and the electrical connector body further comprises an electrical connector locking structure, wherein the first electrical connector terminal core locking structure is configured to be locked to the electrical connector locking structure so as to maintain the electrical connector terminal core assembled with the electrical connector body.

Preferably, the electrical connector said above, wherein the electrical connector terminal inserting structure is of an IDC piercing type inserting structure.

Preferably, the electrical connector said above, wherein the electrical connector body is formed of an insulating plastic material.

Preferably, the electrical connector said above, wherein the electrical connector terminal core is configured to be detachable from the electrical connector body, such that the electrical connector terminal inserting structure is allowed to leave the electrical connector body threading passage through the electrical connector body inserting hole to interrupt the electrical connection between the electrical connector terminal inserting structure and the conductive cable.

Furthermore, the present application further provides a connector assembly configured to be used with a conductive cable, the connector assembly comprising: an electrical connector comprising: an electrical connector body comprising an electrical connector body threading passage and an electrical connector body inserting hole, wherein the electrical connector body threading passage is configured for threading the conductive cable, and the electrical connector body inserting hole is in continuity with the electrical connector body threading passage; an electrical connector conductive terminal comprising an electrical connector terminal inserting structure and an electrical connector terminal engaging structure; and an electrical connector terminal core configured to mate with the electrical connector conductive terminal and to be assembled with the electrical connector body, such that the electrical connector terminal inserting structure is capable of being inserted into the electrical connector body threading passage through the electrical connector body inserting hole to electrically connect the electrical connector terminal inserting structure to the conductive cable; and an engaging connector comprising an engaging connector conductive terminal, wherein the engaging connector conductive terminal comprises an engaging connector terminal engaging structure, and the engaging connector is configured to be assembled with the electrical connector terminal core such that the engaging connector terminal engaging structure is capable of being electrically engaged with the electrical connector terminal engaging structure.

Preferably, the connector assembly said above, wherein the electrical connector terminal engaging structure is a clamping structure configured to electrically clamp the engaging connector terminal engaging structure.

Preferably, the connector assembly said above, wherein the engaging connector further comprises an engaging connector insulating core configured to engaging mate with the engaging connector conductive terminal and to be assembled with the electrical connector terminal core, such that the engaging connector terminal engaging structure is capable of being electrically engaged with the electrical connector terminal engaging structure.

Preferably, the connector assembly said above, wherein the electrical connector terminal core comprises a second electrical connector terminal core locking structure, and the engaging connector insulating core comprises an engaging connector locking structure, wherein the second electrical connector terminal core locking structure is configured to be locked to the engaging connector locking structure so as to maintain the electrical connector terminal core assembled with the engaging connector insulating core.

Preferably, the connector assembly said above, wherein the engaging connector is configured to be detachable from the electrical connector terminal core, such that the engaging connector terminal engaging structure is capable of being electrically disengaged from engaging the electrical connector terminal engaging structure.

Additionally, the present application further provides a signal transmission component assembly comprising: a conductive cable; and an electrical connector comprising: an electrical connector body comprising an electrical connector body threading passage and an electrical connector body inserting hole, wherein the electrical connector body threading passage is configured for threading the conductive cable, and the electrical connector body inserting hole is in continuity with the electrical connector body threading passage; an electrical connector conductive terminal comprising an electrical connector terminal inserting structure; and an electrical connector terminal core configured to mate with the electrical connector conductive terminal and to be assembled with the electrical connector body, such that the electrical connector terminal inserting structure is capable of being inserted into the electrical connector body threading passage through the electrical connector body inserting hole to electrically connect the electrical connector terminal inserting structure to the conductive cable, thereby enabling the electrical connector conductive terminal and the conductive cable to be electrically connected to transmit electrical signals.

Preferably, the signal transmission component assembly said above, further comprising: an engaging connector engaging comprising an engaging connector conductive terminal, wherein the engaging connector conductive terminal comprises an engaging connector terminal engaging structure, and the electrical connector conductive terminal further comprises an electrical connector terminal engaging structure, wherein the engaging connector is configured to be assembled with the electrical connector terminal core such that the engaging connector terminal engaging structure is capable of being electrically engaged with the electrical connector terminal engaging structure, thereby enabling the engaging connector conductive terminal and the electrical connector conductive terminal to be electrically connected to transmit electrical signals.

Preferably, the signal transmission component assembly said above, further comprising an electrical connector supporting component configured to support the electrical connector.

Preferably, the signal transmission component assembly said above, wherein the electrical connector supporting component is a circuit board.

Preferably, the signal transmission component assembly said above, further comprising an electrical connector cooperating component configured to be assembled with or detachable from the electrical connector terminal core so as to define a relative positional relationship between the electrical connector cooperating component and the electrical connector.

Preferably, the signal transmission component assembly said above, wherein the electrical connector terminal core comprises a third electrical connector terminal core locking structure, and the electrical connector cooperating component comprises an electrical connector cooperating component locking structure, wherein the third electrical connector terminal core locking structure is configured to be locked to the electrical connector cooperating component locking structure so as to maintain the electrical connector terminal core assembled with the electrical connector cooperating component.

Compared with the prior art, the present application provides a signal transmission component assembly and an electrical connector and a connector assembly thereof, wherein the signal transmission component assembly, the electrical connector, and the connector assembly are configured to be used with a conductive cable. The conductive terminal of the electrical connector is configured for electrical insertion into the conductive cable. In this way, electrical connection with the conductive cable can be achieved without the need for a cable-end connector, thereby saving internal space within the electronic device and enabling continued development of electronic devices toward a thinner, lighter, and more compact form.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a perspective schematic view of a signal transmission component assembly according to one embodiment of the present application.

FIG. 2 is a perspective schematic view of the signal transmission component assembly from a first viewing angle according to one embodiment of the present application.

FIG. 3 is a perspective schematic view of the signal transmission component assembly from a second viewing angle according to one embodiment of the present application.

FIG. 4 is a perspective schematic view of an electrical connector from a first viewing angle according to one embodiment of the present application.

FIG. 5 is a perspective schematic view of the electrical connector from a second viewing angle according to one embodiment of the present application.

FIG. 6 is a perspective schematic view of the electrical connector from a first viewing angle according to one embodiment of the present application.

FIG. 7 is a perspective schematic view of the electrical connector from a second viewing angle according to one embodiment of the present application.

FIG. 8 is a front schematic view of the signal transmission component assembly according to one embodiment of the present application.

FIG. 9 is a side schematic view of the signal transmission component assembly according to one embodiment of the present application.

FIG. 10 is a sectional schematic view taken along line AA of partial components of the signal transmission component assembly shown in FIG. 8.

FIG. 11 is a sectional schematic view taken along line BB of partial components of the signal transmission component assembly shown in FIG. 8.

FIG. 12 is a sectional schematic view taken along line CC of partial components of the signal transmission component assembly shown in FIG. 9.

FIG. 13 is a sectional schematic view taken along line C′C′ of partial components of the signal transmission component assembly shown in FIG. 9.

FIG. 14 is a top schematic view of the electrical connector according to one embodiment of the present application.

FIG. 15 is a sectional schematic view taken along line DD of partial components of the electrical connector shown in FIG. 14.

FIG. 16 is a perspective schematic view of an engaging connector from a first viewing angle according to one embodiment of the present application.

FIG. 17 is a perspective schematic view of the engaging connector from a second viewing angle according to one embodiment of the present application.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

It should be noted that, for the sake of simplicity and clarity in the disclosure, the same or similar reference numerals will be used to describe components having identical or similar functions in the following embodiments, and descriptions of identical or equivalent features will be omitted.

The present application provides at least one signal transmission component assembly for use in electronic devices, along with its electrical connector and connector assembly. The electrical connector is configured to be inserted with a conductive cable without the use of a cable-end connector, so as to achieve electrical connection with the conductive cable and thereby transmit electrical signals. This allows the internal space of the electronic device to be saved, facilitating the ongoing trend of electronic devices toward thinner, lighter, and more compact designs. The electronic device may be a medical device.

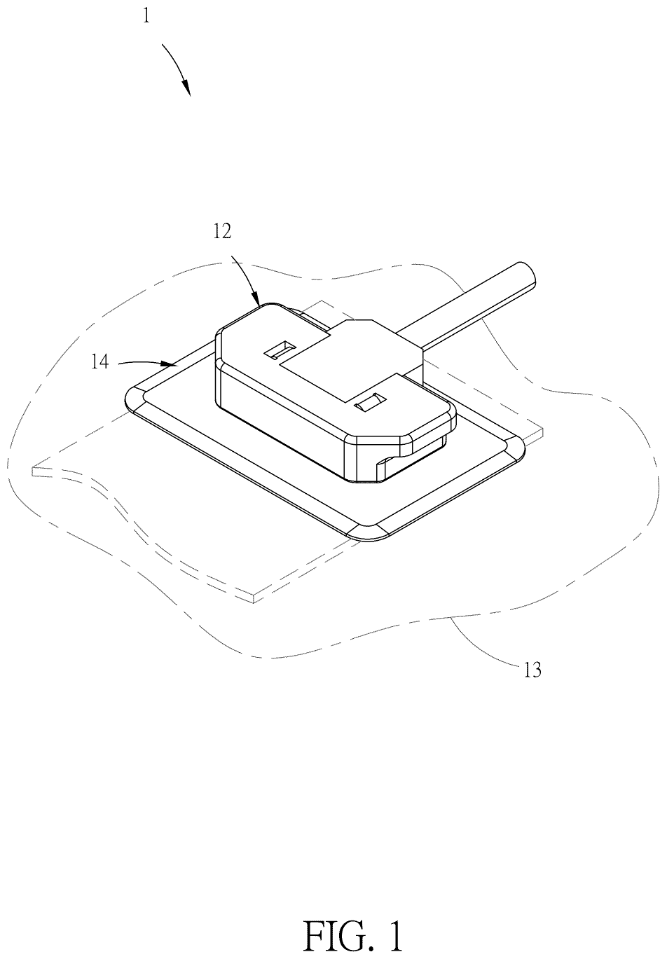

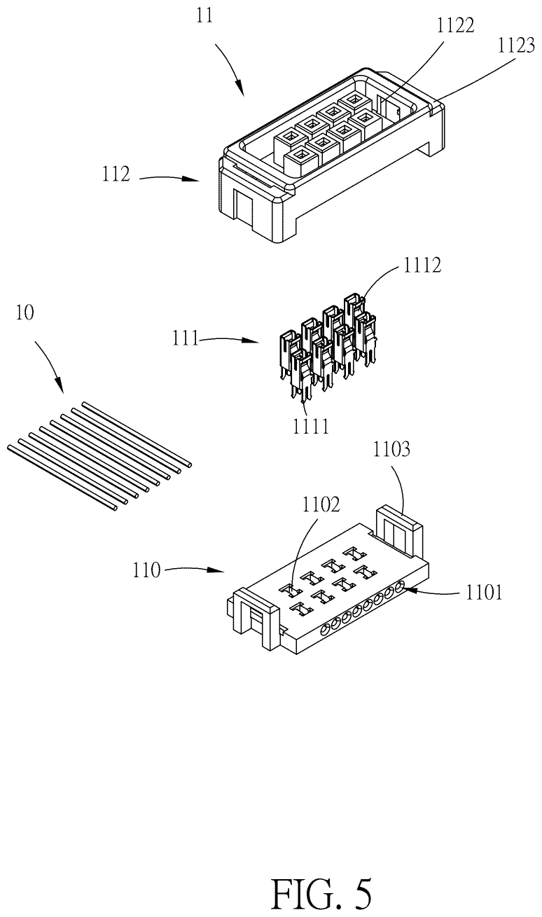

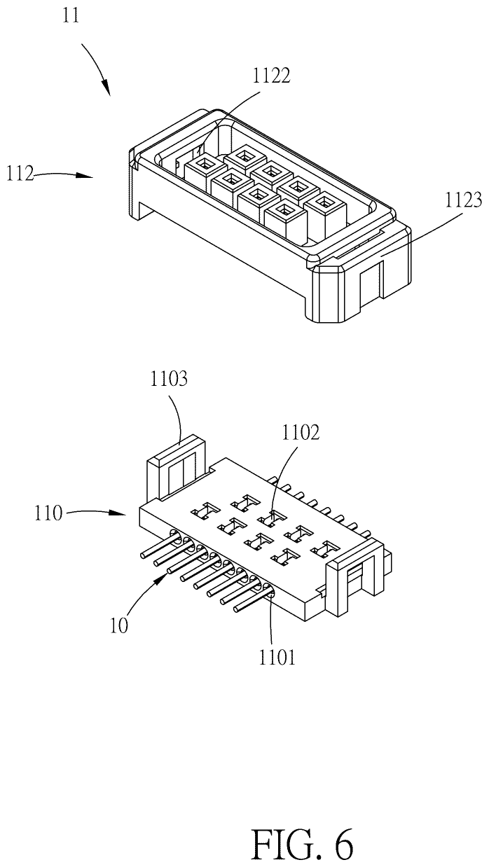

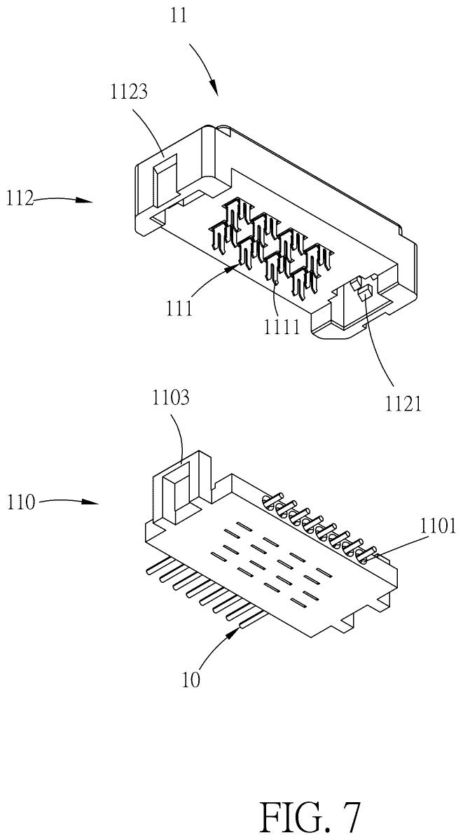

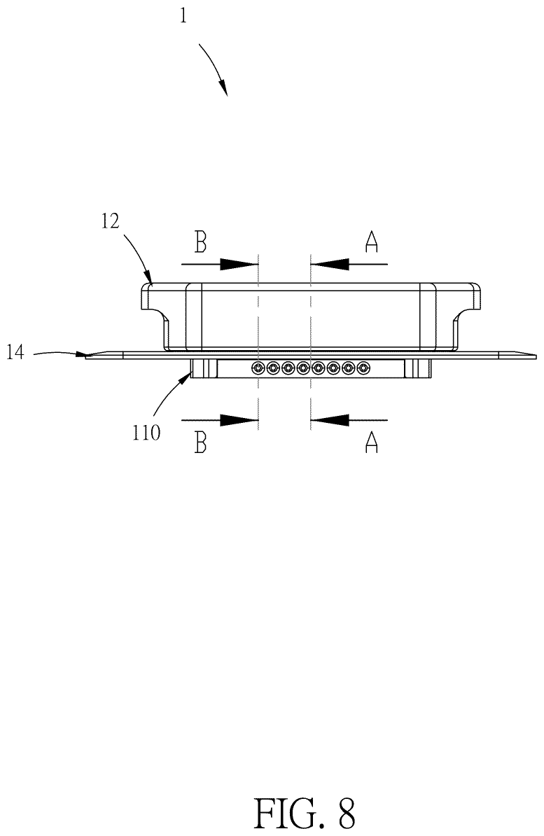

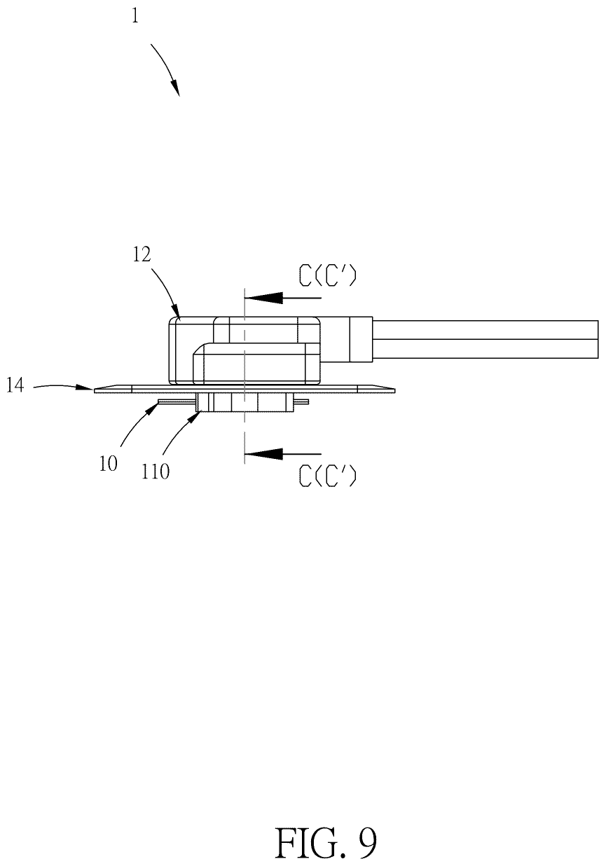

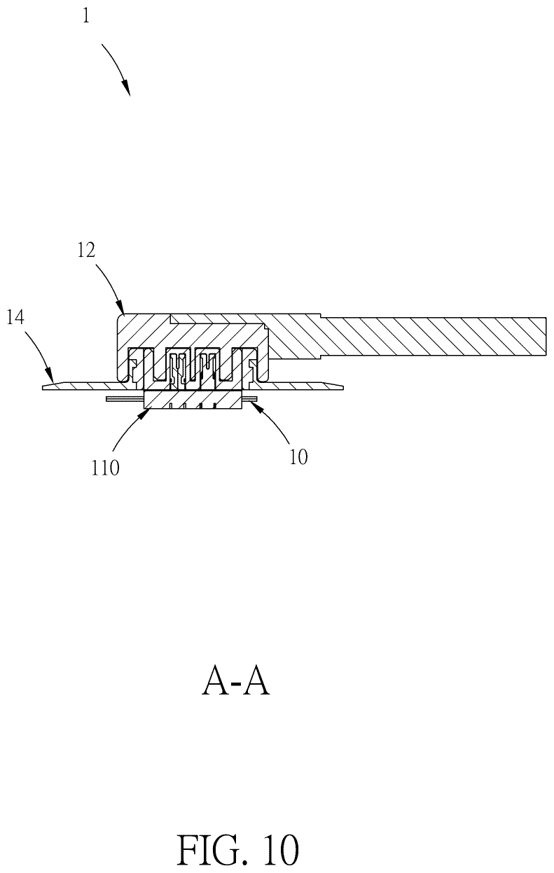

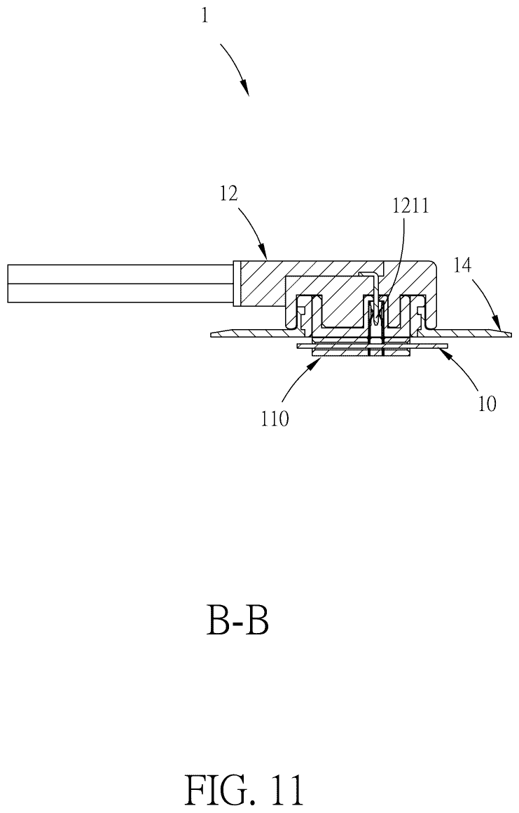

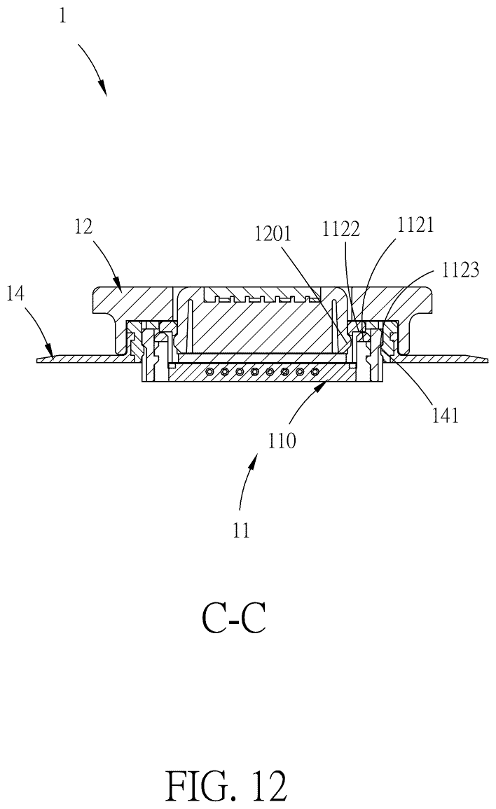

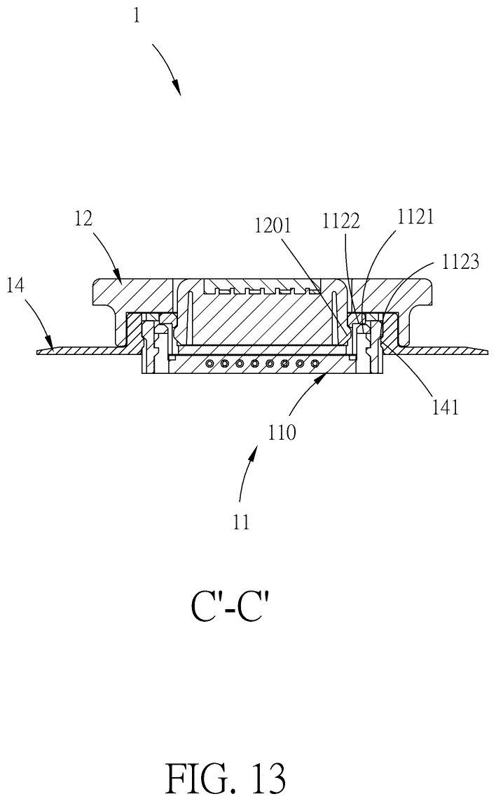

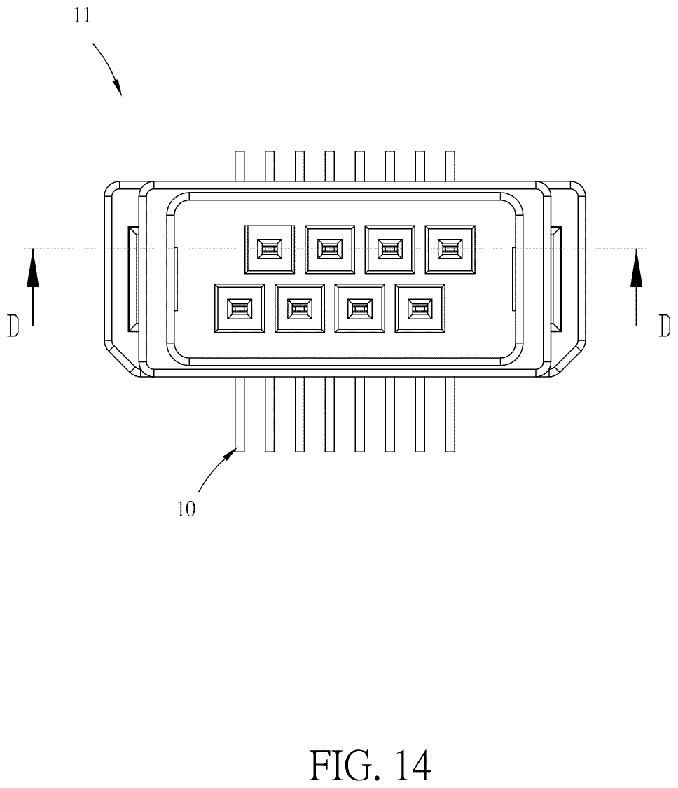

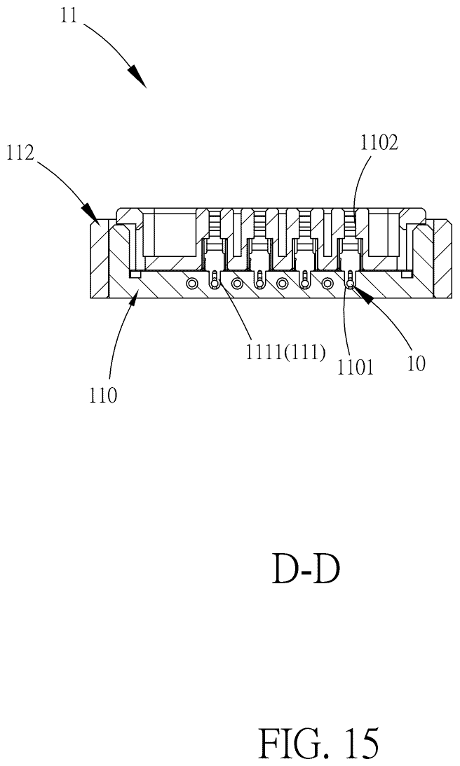

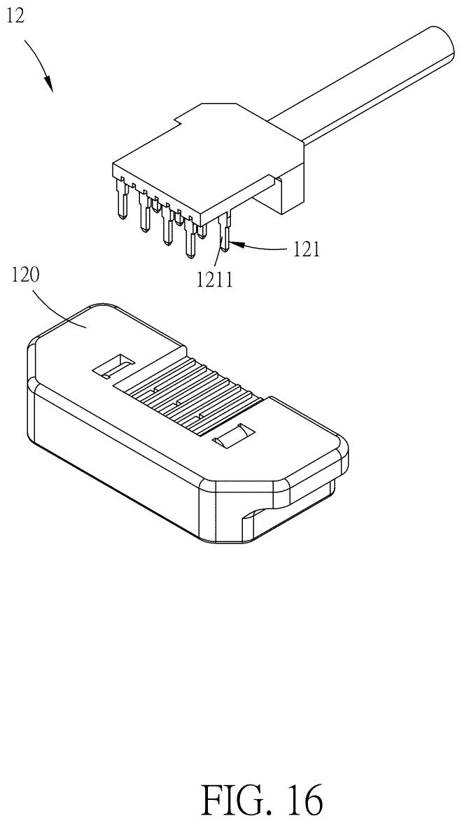

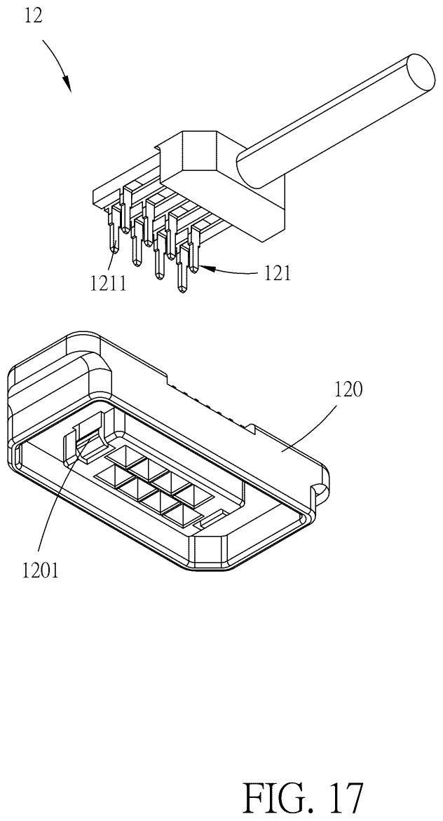

For a detailed description of the embodiments disclosed in the present application, please refer to FIGS. 1 to 17.

In the embodiments shown in FIGS. 1 to 17, at least one signal transmission component assembly 1 and connector assembly A for use in an electronic device are disclosed. The signal transmission component assembly 1 comprises a conductive cable 10, an electrical connector 11, an engaging connector 12, an electrical connector supporting component 13, and an electrical connector cooperating component 14. The conductive cable 10 is configured to transmit electrical signals. The connector assembly A is configured to be used with the conductive cable 10 and comprises the electrical connector 11 and the engaging connector 12.

Regarding the electrical connector 11, it is configured to be used with the conductive cable 10 and comprises an electrical connector body 110, an electrical connector conductive terminal 111, and an electrical connector terminal core 112. The electrical connector body 110 comprises an electrical connector body threading passage 1101 and an electrical connector body inserting hole 1102. In the above embodiment, the electrical connector body threading passage 1101 is configured to guide and receive the conductive cable 10, and the electrical connector body inserting hole 1102 is in continuity with the electrical connector body threading passage 1101. Optionally, the electrical connector body 110 may be formed of an insulating plastic material.

The electrical connector conductive terminal 111 is configured to transmit electrical signals and comprises an electrical connector terminal inserting structure 1111 and an electrical connector terminal engaging structure 1112. The electrical connector terminal core 112 comprises a first electrical connector terminal core locking structure 1121, a second electrical connector terminal core locking structure 1122, and a third electrical connector terminal core locking structure 1123.

In the above embodiment, the electrical connector terminal core 112 is mated with the electrical connector conductive terminal 111, allowing the terminal core 112 to drive the conductive terminal 111. It should be noted that the electrical connector terminal core 112 is combined with the electrical connector body 110 to drive the electrical connector conductive terminal 111, such that the electrical connector terminal inserting structure 1111 inserts into the electrical connector body threading passage 1101 through the electrical connector body inserting hole 1102 to electrically connect with the conductive cable 10, thereby allowing the electrical connector conductive terminal 111 to be electrically connected with the conductive cable 10 for transmitting electrical signals. Therefore, the electrical connector conductive terminal 111 can achieve electrical connection with the conductive cable 10 without the need for a cable-end connector, effectively saving internal space in the electronic device and promoting the miniaturization of the device.

In the above embodiment, the electrical connector body inserting hole 1102 is configured to guide the insertion direction of the electrical connector terminal inserting structure 1111, such that the insertion direction of the terminal inserting structure 1111 aligns with the requirements of electrically connecting to the conductive cable 10, thereby improving the reliability of the electrical signal transmission between the electrical connector 11 and the conductive cable 10.

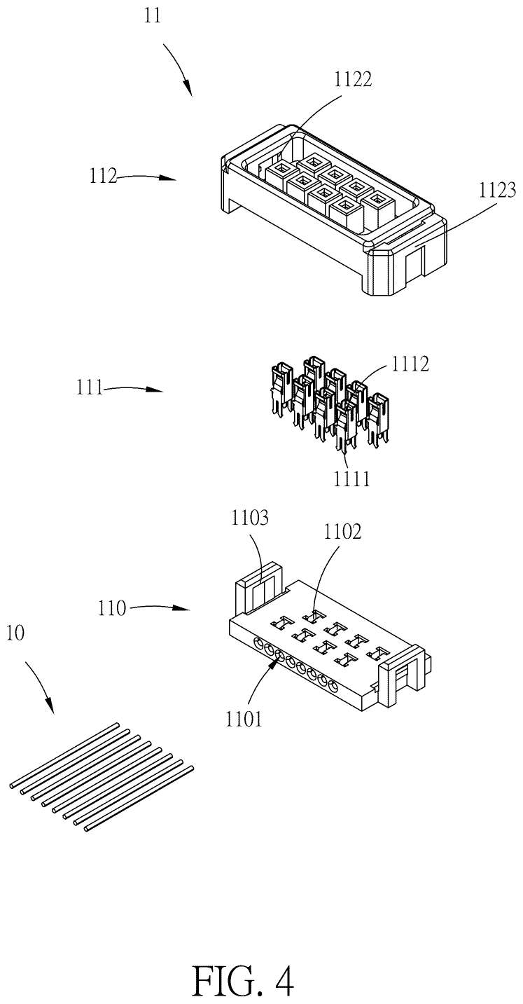

It should be noted that, in the embodiments shown in FIGS. 4 to 7, the electrical connector body 110 further includes an electrical connector locking structure 1103. Correspondingly, the first electrical connector terminal core locking structure 1121 is locked to the electrical connector locking structure 1103, to maintain the combination relationship between the electrical connector terminal core 112 and the electrical connector body 110. Even when the sizes of the terminal core 112 and the connector body 110 become increasingly smaller, the locking engagement ensures that the components do not separate easily under stress, thereby enabling the miniaturization of the electrical connector 11 for use in space-limited electronic devices, allowing the electronic device using the electrical connector 11 (or the signal transmission component assembly 1, or the connector assembly A) to further evolve toward a more compact form factor.

In the embodiments shown in FIGS. 4 to 6 and FIG. 15, the electrical connector terminal inserting structure 1111 is of an IDC piercing type inserting structure. Correspondingly, the electrical connector body inserting hole 1102 and the threading passage 1101 intersect substantially perpendicularly, allowing the terminal inserting structure 1111 to pierce the conductive cable 10 through the inserting hole 1102 and into the threading passage 1101, thereby achieving electrical connection between the electrical connector conductive terminal 111 and the conductive cable 10.

Additionally, it should be noted that, in the above embodiments, the electrical connector terminal core 112 is detachably combinable with the electrical connector body 110, allowing the electrical connector terminal inserting structure 1111 to be removed from the threading passage 1101 via the inserting hole 1102, thus interrupting the electrical insertion into the conductive cable 10 to meet usage requirements.

Regarding the engaging connector 12, the engaging connector 12 comprises an engaging connector insulating core 120 and an engaging connector conductive terminal 121. The engaging connector conductive terminal 121 is configured to transmit electrical signals and comprises an engaging connector terminal engaging structure 1211. The engaging connector insulating core 120 is mated with the engaging connector conductive terminal 121 such that the insulating core 120 drives the conductive terminal 121. It should be noted that in the above embodiment, the engaging connector insulating core 120 (or the engaging connector 12) is combined with the electrical connector terminal core 112 to drive the engaging connector conductive terminal 121, such that the engaging connector terminal engaging structure 1211 is electrically engaged with the electrical connector terminal engaging structure 1112, enabling the engaging connector conductive terminal 121 and the electrical connector conductive terminal 111 to be electrically connected for electrical signal transmission.

Optionally, the electrical connector terminal engaging structure 1112 is a clamping structure configured to electrically clamp the engaging connector terminal engaging structure 1211. In this way, the electrical mating relationship between the electrical connector 11 and the engaging connector 12 is ensured, thereby improving the reliability of the connector assembly A.

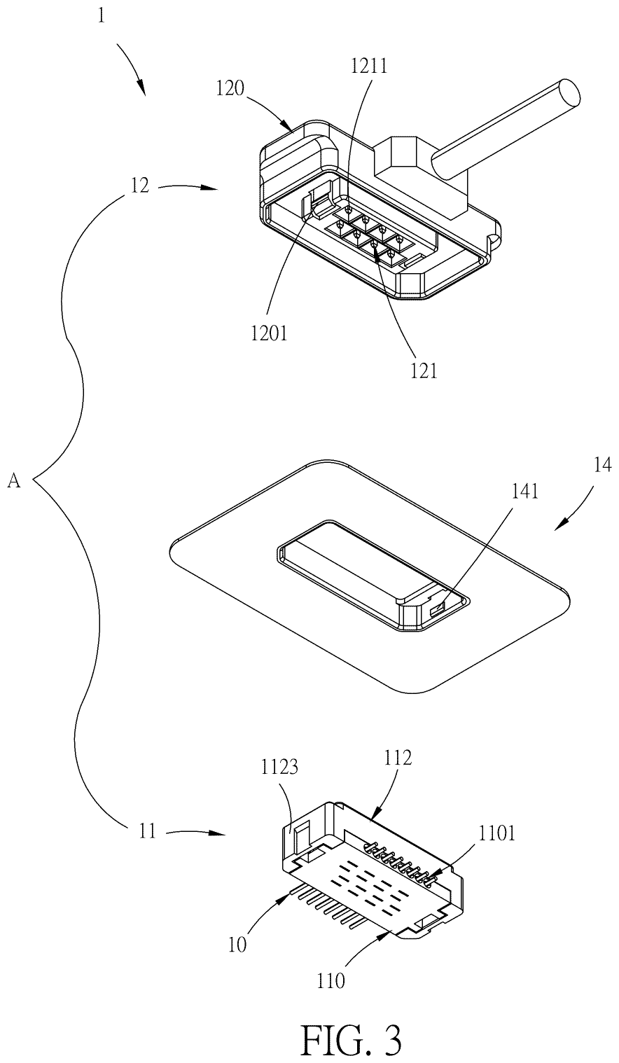

It should be noted that in the embodiments shown in FIGS. 3, 12 to 13, and 17, the engaging connector insulating core 120 comprises an engaging connector locking structure 1201. Correspondingly, the second electrical connector terminal core locking structure 1122 is locked to the engaging connector locking structure 1201 to maintain the combination relationship between the electrical connector terminal core 112 and the engaging connector insulating core 120. Even as the size of the electrical connector terminal core 112 and the engaging connector insulating core 120 is reduced, the electrical connector terminal core 112 can still be locked to the engaging connector insulating core 120, thereby preventing separation due to force. As a result, the electrical connector 11 and the engaging connector 12 can be miniaturized for use in space-constrained electronic devices, allowing the electronic device using the electrical connector 11 and the engaging connector 12 (or the signal transmission component assembly 1, or the connector assembly A) to further develop toward miniaturization.

Additionally, it should be noted that in the above embodiments, the engaging connector 12 is detachably combinable with the electrical connector terminal core 112, allowing the engaging connector terminal engaging structure 1211 to be electrically disconnected from the electrical connector terminal engaging structure 1112 to meet usage requirements.

Regarding the electrical connector supporting component 13, the supporting component 13 is configured to provide support and positioning for the electrical connector 11. Optionally, the supporting component 13 may be a flexible or rigid circuit board capable of transmitting electrical signals. Optionally, it may be a flexible or rigid structural component configured to support and position the electrical connector 11.

Regarding the electrical connector cooperating component 14, the cooperating component 14 is combinable or detachable from the electrical connector terminal core 112 to define a relative positional relationship between the cooperating component 14 and the electrical connector 11 to meet usage requirements. It should be noted that any component configured to cooperate with the electrical connector 11 may serve as the cooperating component 14. Optionally, the cooperating component 14 may be an electronic or non-electronic component that is compatible with the electrical connector 11.

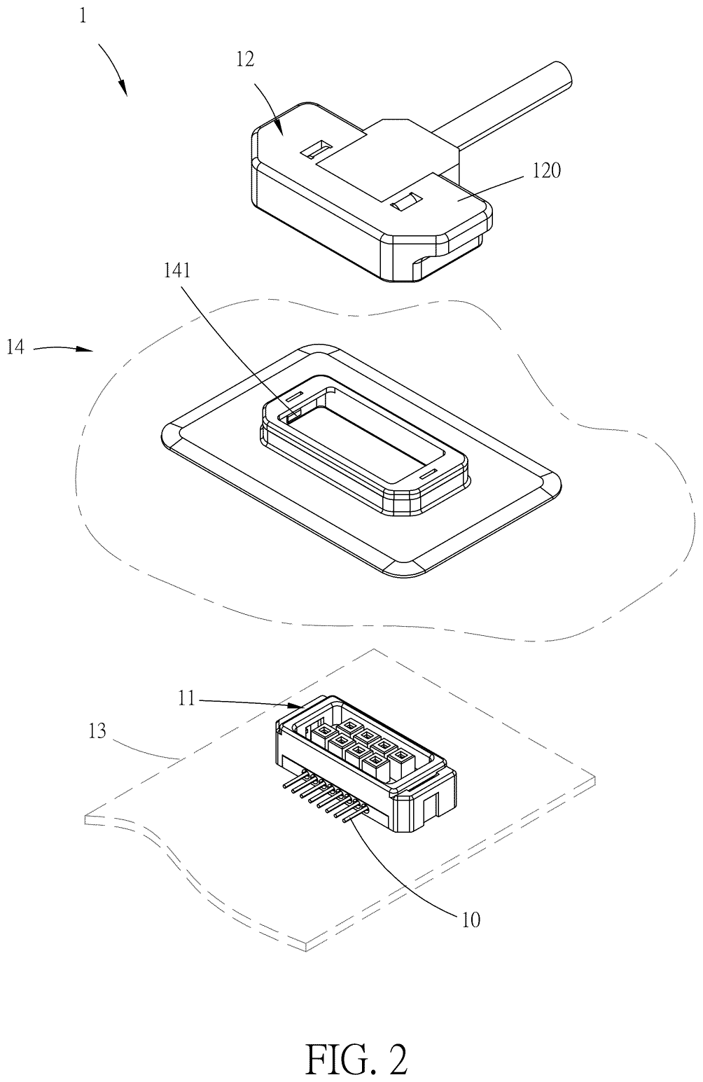

It should be noted that in the embodiments shown in FIGS. 2 to 3, the electrical connector cooperating component 14 comprises an electrical connector cooperating component locking structure 141. Correspondingly, the third electrical connector terminal core locking structure 1123 is locked to the cooperating component locking structure 141 to maintain the combination relationship between the electrical connector terminal core 112 and the cooperating component 14. Even as the size of the terminal core 112 and the cooperating component 14 is reduced, the terminal core 112 can still be locked to the cooperating component 14 to prevent separation due to force, thereby allowing the electrical connector 11 and the cooperating component 14 to be miniaturized for use in space-constrained electronic devices, enabling the electronic device using the electrical connector 11 and the cooperating component 14 (or the signal transmission component assembly 1, or the connector assembly A) to further develop toward miniaturization.

It should be noted that the components of the above-mentioned signal transmission component assembly, electrical connector, and connector assembly may be selectively omitted or added according to actual usage, and are not limited to those described above.

For example, in the present application, the electrical connector may comprise an electrical connector body, an electrical connector conductive terminal, and an electrical connector terminal core. The electrical connector body comprises a threading passage and an inserting hole. The threading passage is configured for threading a conductive cable, and the inserting hole is in continuity with the threading passage. The electrical connector conductive terminal comprises a terminal inserting structure. The terminal core is mated with the conductive terminal and combinable with the electrical connector body, such that the terminal inserting structure inserts into the threading passage through the inserting hole to electrically connect with the conductive cable.

Furthermore, in the present application, the connector assembly comprises an electrical connector and an engaging connector. The electrical connector comprises an electrical connector body, an electrical connector conductive terminal, and an electrical connector terminal core. The electrical connector body comprises a threading passage and an inserting hole. The threading passage is configured for threading a conductive cable, and the inserting hole is in continuity with the threading passage. The electrical connector conductive terminal comprises a terminal inserting structure and a terminal engaging structure. The terminal core is mated with the conductive terminal and combinable with the electrical connector body, such that the terminal inserting structure inserts into the threading passage through the inserting hole to electrically connect with the conductive cable. The engaging connector comprises an engaging connector conductive terminal having an engaging connector terminal engaging structure. The engaging connector is combined with the terminal core such that the engaging connector terminal engaging structure is electrically engaged with the terminal engaging structure of the electrical connector.

Moreover, in the present application, the signal transmission component assembly comprises a conductive cable and an electrical connector. The electrical connector comprises an electrical connector body, an electrical connector conductive terminal, and an electrical connector terminal core. The electrical connector body comprises a threading passage and an inserting hole. The threading passage is configured for threading a conductive cable, and the inserting hole is in continuity with the threading passage. The electrical connector conductive terminal comprises a terminal inserting structure. The terminal core is mated with the conductive terminal and combinable with the electrical connector body, such that the terminal inserting structure inserts hole into the threading passage through the inserting to electrically connect with the conductive cable, enabling the electrical connector conductive terminal and the conductive cable to be electrically connected for electrical signal transmission.

In summary, the signal transmission component assembly, along with its electrical connector and connector assembly of the present application, is configured to be used with a conductive cable, wherein the conductive terminal of the electrical connector is electrically inserted into the conductive cable. In this way, electrical connection with the conductive cable can be achieved without the need for a cable-end connector, thereby saving the internal space of the electronic device and allowing the device to continue developing toward a thinner, lighter, and more compact form.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. An electrical connector configured to be used with a conductive cable, the electrical connector comprising:
an electrical connector body comprising an electrical connector body threading passage and an electrical connector body inserting hole, wherein the electrical connector body threading passage is configured for threading the conductive cable, and the electrical connector body inserting hole is in continuity with the electrical connector body threading passage;
an electrical connector conductive terminal comprising an electrical connector terminal inserting structure; and
an electrical connector terminal core configured to mate with the electrical connector conductive terminal and to be assembled with the electrical connector body, such that the electrical connector terminal inserting structure is capable of being inserted into the electrical connector body threading passage through the electrical connector body inserting hole to be inserted into the conductive cable to electrically connect the electrical connector terminal inserting structure to the conductive cable.

2. The electrical connector of claim 1, wherein the electrical connector body inserting hole and the electrical connector body threading passage intersect substantially perpendicularly.

3. The electrical connector of claim 1, wherein the electrical connector terminal core comprises a first electrical connector terminal core locking structure, and the electrical connector body further comprises an electrical connector locking structure, wherein the first electrical connector terminal core locking structure is configured to be locked to the electrical connector locking structure so as to maintain the electrical connector terminal core assembled with the electrical connector body.

4. The electrical connector of claim 1, wherein the electrical connector terminal inserting structure is of an IDC piercing type inserting structure.

5. The electrical connector of claim 1, wherein the electrical connector body is formed of an insulating plastic material.

6. The electrical connector of claim 1, wherein the electrical connector terminal core is configured to be detachable from the electrical connector body, such that the electrical connector terminal inserting structure is allowed to leave the electrical connector body threading passage through the electrical connector body inserting hole to interrupt the electrical connection between the electrical connector terminal inserting structure and the conductive cable.

7. A connector assembly configured to be used with a conductive cable, the connector assembly comprising:
an electrical connector comprising:
an electrical connector body comprising an electrical connector body threading passage and an electrical connector body inserting hole, wherein the electrical connector body threading passage is configured for threading the conductive cable, and the electrical connector body inserting hole is in continuity with the electrical connector body threading passage;
an electrical connector conductive terminal comprising an electrical connector terminal inserting structure and an electrical connector terminal engaging structure; and
an electrical connector terminal core configured to mate with the electrical connector conductive terminal and to be assembled with the electrical connector body, such that the electrical connector terminal inserting structure is capable of being inserted into the electrical connector body threading passage through the electrical connector body inserting hole to electrically connect the electrical connector terminal inserting structure to the conductive cable; and
an engaging connector comprising an engaging connector conductive terminal, wherein the engaging connector conductive terminal comprises an engaging connector terminal engaging structure, and the engaging connector is configured to be assembled with the electrical connector terminal core such that the engaging connector terminal engaging structure is capable of being electrically engaged with the electrical connector terminal engaging structure.

8. The connector assembly of claim 7, wherein the electrical connector terminal engaging structure is a clamping structure configured to electrically clamp the engaging connector terminal engaging structure.

9. The connector assembly of claim 7, wherein the engaging connector further comprises an engaging connector insulating core configured to engaging mate with the engaging connector conductive terminal and to be assembled with the electrical connector terminal core, such that the engaging connector terminal engaging structure is capable of being electrically engaged with the electrical connector terminal engaging structure.

10. The connector assembly of claim 9, wherein the electrical connector terminal core comprises a second electrical connector terminal core locking structure, and the engaging connector insulating core comprises an engaging connector locking structure, wherein the second electrical connector terminal core locking structure is configured to be locked to the engaging connector locking structure so as to maintain the electrical connector terminal core assembled with the engaging connector insulating core.

11. The connector assembly of claim 9, wherein the engaging connector is configured to be detachable from the electrical connector terminal core, such that the engaging connector terminal engaging structure is capable of being electrically disengaged from engaging the electrical connector terminal engaging structure.

12. A signal transmission component assembly comprising:
a conductive cable; and
an electrical connector comprising:
an electrical connector body comprising an electrical connector body threading passage and an electrical connector body inserting hole, wherein the electrical connector body threading passage is configured for threading the conductive cable, and the electrical connector body inserting hole is in continuity with the electrical connector body threading passage;
an electrical connector conductive terminal comprising an electrical connector terminal inserting structure; and
an electrical connector terminal core configured to mate with the electrical connector conductive terminal and to be assembled with the electrical connector body, such that the electrical connector terminal inserting structure is capable of being inserted into the electrical connector body threading passage through the electrical connector body inserting hole to electrically connect the electrical connector terminal inserting structure to the conductive cable, thereby enabling the electrical connector conductive terminal and the conductive cable to be electrically connected to transmit electrical signals.

13. The signal transmission component assembly of claim 12, further comprising: an engaging connector engaging comprising an engaging connector conductive terminal, wherein the engaging connector conductive terminal comprises an engaging connector terminal engaging structure, and the electrical connector conductive terminal further comprises an electrical connector terminal engaging structure, wherein the engaging connector is configured to be assembled with the electrical connector terminal core such that the engaging connector terminal engaging structure is capable of being electrically engaged with the electrical connector terminal engaging structure, thereby enabling the engaging connector conductive terminal and the electrical connector conductive terminal to be electrically connected to transmit electrical signals.

14. The signal transmission component assembly of claim 12, further comprising an electrical connector supporting component configured to support the electrical connector.

15. The signal transmission component assembly of claim 14, wherein the electrical connector supporting component is a circuit board.

16. The signal transmission component assembly of claim 12, further comprising an electrical connector cooperating component configured to be assembled with or detachable from the electrical connector terminal core so as to define a relative positional relationship between the electrical connector cooperating component and the electrical connector.

17. The signal transmission component assembly of claim 16, wherein the electrical connector terminal core comprises a third electrical connector terminal core locking structure, and the electrical connector cooperating component comprises an electrical connector cooperating component locking structure, wherein the third electrical connector terminal core locking structure is configured to be locked to the electrical connector cooperating component locking structure so as to maintain the electrical connector terminal core assembled with the electrical connector cooperating component.
